(19) United States
(12) Patent Application Publication
(10) Pub. No.: US 2016/0232922 A1
(43) Pub. Date: Aug. 11, 2016

(54) Communication Analyzer and Recommendation System

(71) Applicant: Simon Hickey, Albuquerque, NM (US)

(72) Inventors: Simon Hickey, Albuquerque, NM (US); Portia Adams Hickey, Purley (GB)

(21) Appl. No.: 14/616,857

(22) Filed: Feb. 9, 2015

(51) Int. Cl. G10L 25/63; G06F 17/27

(52) U.S. Cl. CPC G10L 25/63; G06F 17/2785

(57) ABSTRACT

Disclosed is a method to analyze content, usually in the form of communication, to determine psychological characteristics and communication styles of the contact that authored the content, and create a psychological characteristics and communication style profile of the contact. The profile of the contact can be used to generate recommendations on how to communicate more effectively with the contact, and the recommendations can relate to the content created by the user which is proposed to be sent to the contact. The recommendations can general or specific recommendations and can include further inputs of context, platform and purpose which may influence the recommendations.

### BACKGROUND OF THE INVENTION

1. Field of the Invention

The present invention relates to providing analysis of psychological characteristics and communication styles of authored content from individuals, usually in the form of communications. This analysis allows for the user of the invention to gain insight from the communications or content authored by an individual, and to obtain recommendations when creating content to send to that individual. The recommendations may take the form of general recommendations or specific recommendations to customize the content being communicated.

2. Description of the Prior Art

Human beings communicate in many ways and for many reasons. When we are communicated to in a way that we find more aligned to us, we are more likely to process, engage and recall the content of the communication.

For these reasons, when we communicate with others we ideally would like to do it in a way that resonates with the recipient of our communication. Each individual has different psychological characteristics that frame how they communicate with others and how they would like others to be communicated with them. In addition, individuals can have different styles of communication depending upon; platform for the communication, context of the communication and their purpose for communicating. These variables are all important in successful communication but are usually too complex for an individual to assess in most communication situations.

Human beings try to consciously or subconsciously determine characteristics of the person we are communicating with based upon prior communication experiences and apply our instincts, education and best practices to communicate more effectively. We also try to determine the motivations of the person or group, and the reasons for the communication. We often try to mirror or craft our communication style to suit the other person, also taking into consideration context, platform and purpose of the communication.

There are numerous invention efforts being made to recommend content for an individual or group based on personality traits or demographics. There are also inventions to dynamically change an electronic user interface based on psychological profiling. These initiatives don't address the need to understand the key psychological characteristics and communication styles of communications received from an individual and respond in a more engaging and customized way that resonates with the recipient taking into consideration their psychological characteristics and/or communication style.

U.S. Pat. No. 8,585,9328 describes a method for examining computer user activity to assess user psychology.

This process is limited to the examining the user activity and not the content created or communications between the parties. Furthermore the prior art does not provide recommendations for the user based on the content created for the purpose of communication.

U.S. Pat. No. 8,892,171 describes a method for gathering data between mobile devices to build a psychological profile.

This process is limited to tracking activity and not the content of communications between devices. It is also limited to making changes to the user interface of the device rather than recommendations regarding content communicated between parties on their devices.

U.S. Pat. No. 8,560,486 describes a method for determining the Big 5 Personality Traits from a consumption profile and recommending content.

This process is limited to determining one methodology of psychological assessment based on consumption and then recommending content to consume. This does not address methodology of communication analysis and providing recommendations how to improve authored content.

U.S. Pat. No. 8,775,162 describes a method for speech signal processing for determining psychological characteristics.

This process is limited to determining certain psychological characteristics and applying defined psychology methodology to determine behavior risks and threats from that author.

### SUMMARY OF THE INVENTION

The present invention provides analysis of psychological characteristics and communication styles of authored content, usually in the form of communications. This analysis allows for the user to gain insight on authored communications or content from individuals and obtain recommendations when creating content to send to those individuals. The recommendations may take the form of general suggestions or specific recommendations on how to edit and/or customize the content for communication.

It is therefore a primary object of the present invention to analyze the psychological characteristics and communication style of a contact, utilizing a sample of their authored content and/or communication, in order to build a profile of the contact.

It is another object of the present invention to provide general recommendations on how best to communicate with the contact based on the psychological characteristics and/or communication style profile derived from the analysis of the contact's prior communications or content.

It is another object of the present invention to provide specific recommendations in relation to the user's content on how to better communicate with the contact based on the psychological characteristics and/or communication style profile derived from the contact's prior communications or content.

It is another object of the present invention to provide a feature to automatically change content for communication authored by a user based on the profile of a contact.

It is still another object of the present invention to make changes to recommendations based on the platform and context of the communication and/or the purpose for the communications.

These and other objects of the present invention, will become apparent to those skilled in the art upon reading the accompanying description, drawings, and claims set forth herein. The headings provided herein are for the convenience of the reader only. No headings should be construed to limiting upon the content in any way.

### BRIEF DESCRIPTION OF THE DRAWINGS

FIG. 1 is a diagram of the inter-relations within the Communication Analyzer Database.

FIG. 2 is a diagram to show the processes involved in creating a psychological characteristic and/or communication style profile of a contact.

FIG. 3 is a diagram to illustrate the process to provide recommendations to the user using the Communication Analyzer.

### DETAILED DESCRIPTION OF THE INVENTION

### 1. Definitions

Author—includes physically or intellectually creating the content.

Communicate—making available, posting, or sending voice and text across various platforms for an individual or group.

Communication—any content authored and provided for consumption for an individual or group.

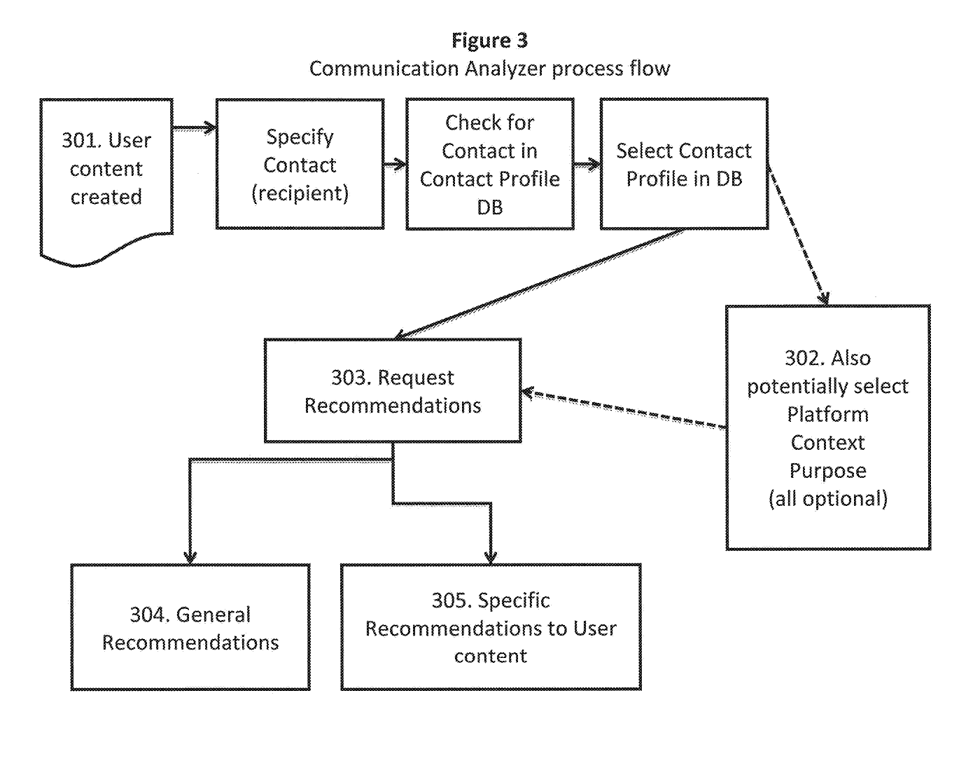

Communication Analyzer—the invention covered by this application and process illustrated in FIG. 3.

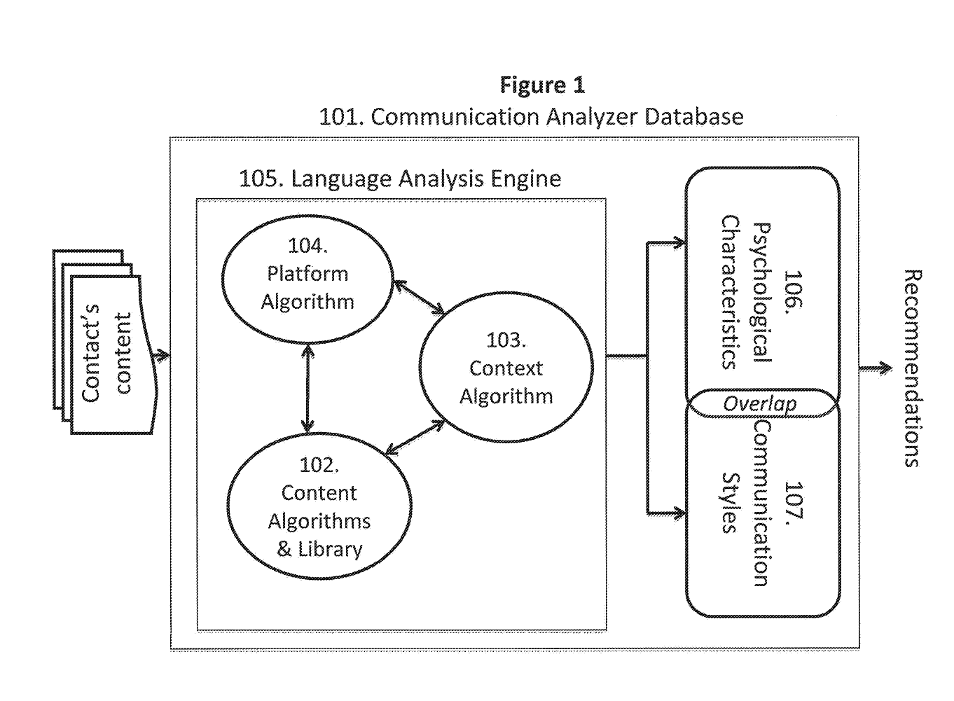

Communication Analyzer Database—see FIG. 1.

Communication Style—a pattern of communication not used by all individuals.

Contact—the individual who authored the content or communication the user received or found, or is the proposed recipient/s of the content the user authors.

Contact Profile—the psychological characteristic and/or communication style analysis for a specific contact. This profile may include references to platform and context.

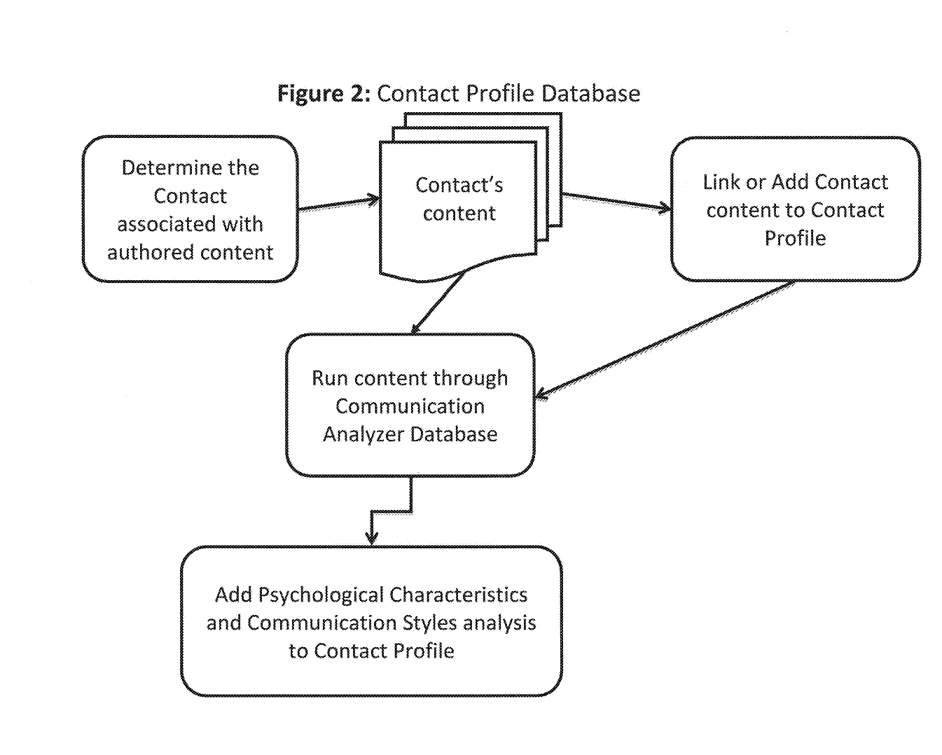

Contact Profiler Database—see FIG. 2.

Emoticons—graphic abbreviations of expressions or text.

Identifier—a potentially unique identifier for a contact for example name, number, code or email.

Layout—any combination of text or text spacing in a pattern.

Phrase—combination of words in any language or communication medium.

Platform—electronic devices, telecommunication devices, software, websites and media used for posting, sending and receiving communication or content.

Profile—profile of a contact based on analysis of psychological characteristics and/or communication style.

Psychological Characteristics—any form of psychological theory or analysis of an individual or group including motivation.

Punctuation—any known punctuation used in text formally or informally.

Text—any form of electronic written communication.

User—the user of the invention which in some cases may be more an individual.

Voice Characteristics—identifying traits of an individual's voice not limited to pitch and volume.

Word—a word, an acronym, abbreviation, misspelling, in any language or communication medium. Singular or plural.

### 2. Best Mode of Invention

FIG. 3 shows the process of the best mode contemplated by the inventor for the Communication Analyzer, according to the concepts of the present invention.

### 3. How to Make the Invention

As can be seen by the drawings, the Communication Analyzer utilizes the Communication Analyzer Database to determine psychological characteristics and communication styles from content authored by the contacts of the user, as well as provide recommendations on how best to communicate with the contact.

The Communication Analyzer Database (101) is made up of a Language Analysis Engine (105) which includes: Content Algorithms and Library (102) for grouping and determining relationships of words, phrases, punctuation, layout, emoticons and voice characteristics; a Context Algorithm (103) for determining relationships between communications in a social, business or organizational setting; and a Platforms Algorithm (104) for determining relationships between communications in email, text, instant messaging, presentations and voice. Associations of content, context and platform are mapped to psychological characteristics (106) and/or communication styles (107) using algorithms to determine the relative strength of the associations. These associations are dynamic, because it is a combination of an existing database of associations, which may be removed or downgraded, and new associations that are established through ongoing analysis

As outlined in FIG. 2, the Contact Profiler Database, when a contact's communication is received or authored content found, a contact profile can be established to analyze the content and link the psychological characteristic and/or communication style analysis to the contact. The contact profile includes a unique identifier of the contact. Additional content authored by the contact can be added to the profile and re-analyzed by the Communication Analyzer Database (FIG. 1). The profiles of contacts can be shared within a group or organization based upon settings by the user. A user will be able to view a profile of a contact after a profile is created.

As outlined in FIG. 3, when a user wishes to send a communication (301) to a contact, the user can first search to see if the contact has a contact profile in the Contact Profiler Database (FIG. 2). If the contact has a profile, the user can seek recommendations (303) on how best to communicate with the contact. The recommendation may be a general recommendation or specific recommendations.

General recommendations (304) will be advice on how best to communicate with the contact based on the psychological characteristics and/or communication style profile with limited or no reference to the content the user is proposing to communicate to the contact. Specific recommendations (305) will take into consideration the content that the user is proposing to communicate to the contact, and may include suggestions on editing, headers, modifying a layout, or rating user content based on the contact profile. Specific recommendations may also include automatic changes to the content. These recommendations can be ignored, rejected, accepted in part or in full.

Recommendations may vary based on the context (103) of the communication. In the case of communication in a social context, the content will often be different to that used in a business context. The user can specify the context of the communication and the recommendations may change accordingly (302).

Recommendations may also vary based upon the platform (104) used. For example, the content communication via email will be different to content used in a presentation. If the user opts to select a platform the recommendations may also change (302). One distinctly different platform is voice. In receiving communication content via voice, voice characteristics such as pitch and volume will be analyzed to determine psychological characteristics and communication style. Recommendations for communicating to a contact using voice may also include utilizing specific voice characteristics in the recommendations.

Recommendations may also vary based upon purpose of the communication. A communication for the purpose of selling may be different than communication for the purpose of organizational management. If a user selects a purpose for the communication, the recommendations may change.

### 4. How to Use the Invention

The user of the invention will select or input the content of a contact to be analyzed by means such as, but not limited to, highlighting, scrolling, tagging, cutting and pasting, copying, or recording the content. In some cases the user may choose to have content automatically analyzed when received from a contact.

The content would be analyzed by the Communication Analyzer Database to determine psychological characteristics and/or communication styles of the author. Results would be linked to the contact identifier and a contact profile would be created. Additional content could be added and submitted for analysis with the results included in the contact profile. This contact profile could be viewed by the user once it is created.

When the user plans to communicate with a contact, the user can see if an existing contact profile exists for the contact and if so, seek recommendations how best to communicate with the contact. These recommendations can be general recommendations or specific recommendations usually based upon the content the user proposes to communicate to the contact. For example, specific recommendations may include scoring of content, prompts, highlighted editorial changes or automatic editorial changes. The recommendations may also vary based upon the context of the communication and/or the platform for the communication, and/or the purpose of the communication. The user can choose to ignore, reject, accept all or none of the recommendations.

1. A method for determining psychological characteristics and communication styles comprising steps of: selecting or inputting content authored by a contact; analyzing content authored by a contact using algorithms; finding associations of topics, words, phrases, punctuation, emoticons and layouts with psychological characteristics and communication styles; and maintaining a record of the results of the analysis.

2. The method according to claim 1, further comprising analysis of voice characteristics.

3. The method according to claim 2, further comprising analysis of context of content.

4. The method according to claim 2, further comprising analysis of platform used for content.

5. The method according to claim 2, further comprising analysis of context of content and platform used for content.

6. The method according to claim 5, further comprising of a means for viewing the psychological characteristics and communication styles analysis of a contact.

7. The method according to claim 6, further comprising of a means for adding psychological characteristics and communication styles analysis of a contact to create profiles of contacts.

8. The method according to claim 7, further comprising of a means for sharing the profiles with other users.

9. A method for obtaining recommendations on communicating with a contact comprising steps of: selecting or imputing content authored by a contact; analyzing one or both of psychological characteristics and communication styles from content authored by a contact; creating a profile of each contact with the results of the analysis of their content; and providing the user with recommendations on communicating with that contact based on the analysis.

10. The method according to claim 9, further comprising of the means for specifying the platform for the proposed communication with the contact.

11. The method according to claim 9, further comprising of the means for specifying the context for the proposed communication with the contact.

12. The method according to claim 9, further comprising of the means for specifying the purpose for the proposed communication with the contact.

13. The method according to claim 9, further comprising of the means for specifying at least one of: platform, context and purpose, for the proposed communication with the contact.

14. A method for obtaining recommendations on communicating with a contact comprising steps of: selecting or inputting content authored by a contact; analyzing one or both of psychological characteristics and communication styles, from content authored by a contact; creating a profile of each contact with the results of the analysis of their content; authoring content to communicate to the contact; and obtaining recommendations for varying the content to be communicated to the contact.

15. The method according to claim 14, further comprising recommendations that take into consideration at least one of platform, context and purpose, if specified.

16. The method according to claim 15, further comprising of editorial recommendations to user content.

17. The method according to claim 15, further comprising of scoring or rating all or parts of the user content.

18. The method according to claim 15, further comprising of identifying parts of content that may need changes.

19. The method according to claim 15, further comprising of automatic changes to user content.

20. The method according to claim 16, further comprising of methods where recommendations or changes to user content can be ignored, rejected, accepted in part or in full.

21. The method according to claim 19, further comprising of methods where recommendations or changes to user content can ignored, rejected, accepted in part or in full.
